(19) United States
(12) Patent Application Publication
(10) Pub. No.: US 2024/0418623 A1
(43) Pub. Date: Dec. 19, 2024

(54) DETERMINING ASPECT RATIO DEPENDENT PORE SIZE DISTRIBUTIONS FOR MULTIPLE PORE TYPES AND PROCESSES FOR USING SAME

(71) Applicant: Schlumberger Technology Corporation, Sugar Land, TX (US)

(72) Inventors: Jun Tao Ma, Beijing (CN); Lin Liang, Belmont, MA (US); Muyang Zhang, Beijing (CN); Mohammed Fadhel Al-Hamad, Dhahran (SA); Marie Van Steene, Dhahran (SA); Wael Abdallah, Sugar Land, TX (US); Shouxiang Mark Ma, Dhahran (SA)

(21) Appl. No.: 18/744,264

(22) Filed: Jun. 14, 2024

Related U.S. Application Data
(60) Provisional application No. 63/508,071, filed on Jun. 14, 2023.

(51) Int. Cl. G01N 15/08; E21B 44/00; E21B 49/00; G01N 23/2251

(52) U.S. Cl. CPC G01N 15/082; G01N 2015/0813

(57) ABSTRACT

Process for determining rock permeability. In some embodiments, the process can include determining a volume-based aspect ratio distribution of pores in a rock sample from a digital image of the sample, grouping the volume-based aspect ratio distribution into two or more pore types, selecting an initial pore type from the two or more pore types, obtaining mercury injection capillary pressure (MICP) data of the sample, creating a volume forward model and a frequency forward model using the MICP data, deriving an initial volume-based pore size distribution and an initial frequency-based pore size distribution for the initial pore type using the volume and the frequency forward models, respectively, selecting either the initial volume-based or the initial frequency-based distribution based on the forward models, and optimizing the selected distribution using an inversion of the MICP data with combinations of two or more pore type distributions to create an optimized distribution.

This application claims priority to and the benefit of U.S. Provisional Patent Application Ser. No. 63/508,071, entitled “Determining Aspect Ratio Dependent Pore Size Distributions for Multiple Pore Types and Processes for Using Same,” filed Jun. 14, 2024, all of which is hereby incorporated by reference in their entireties for all purposes.

### FIELD

Embodiments provided herein relate to determining pore size distributions. More particularly, such embodiments relate to determining aspect ratio dependent pore size distributions for multiple pore types and processes for using same.

### BACKGROUND

Pore throat size distribution or simply pore size distribution can be one of the most important properties for characterizing a pore system within a formation and estimating rock permeability of same. The current practice typically involves a single aspect ratio (a), defined as the ratio of short axis diameter over the long axis diameter of a pore which assumes that the pore shape is cylindrical tubes in the model. In real natural rocks or formations, especially in carbonate rocks or tight formations, however, the pores are typically composed of multiple pore types with varying aspect ratios, e.g., stiff pores with an a between 0.7 and 0.8, reference pores with an a between 0.12 and 0.15, and crack pores with an a between 0.02 and 0.03. In addition, although experiment-based analytical equations used to describe mercury injection capillary pressure (MICP) data are available, their fitting parameters are insufficient to quantitatively describe the complex geometrical characteristics for different pore size distribution types.

There is a need, therefore, for improved processes for estimating rock permeability that accounts for varying pore types.

### SUMMARY

A process for determining rock permeability is provided. The process can include acquiring a rock sample from a subterranean formation, determining a volume-based aspect ratio distribution of pores in the rock sample from a digital image of the rock sample, grouping the volume-based aspect ratio distribution into two or more pore types, selecting an initial pore type from the two or more pore types, obtaining mercury injection capillary pressure data of the rock sample, creating a volume forward model using the mercury injection capillary pressure data, deriving an initial volume-based pore size distribution for the initial pore type using the volume forward model, creating a frequency forward model using the mercury injection capillary pressure data, deriving an initial frequency-based pore size distribution for the initial pore type using the frequency forward model, selecting either the initial volume-based pore size distribution or the initial frequency-based pore size distribution based on the volume forward model and the frequency forward model to provide a selected distribution, and optimizing the selected distribution using an inversion of the mercury injection capillary pressure data with combinations of two or more pore type distributions to create an optimized distribution.

In other embodiments, the process can include determining porc types of a rock having different average ratios of a short axis diameter over a long axis diameter (α) from sonic measurements to provide a volume-based aspect ratio distribution, grouping the volume-based aspect ratio distribution into two or more pore types, selecting an initial pore type from the two or more pore types, obtaining mercury injection capillary pressure data of the rock sample, creating a volume forward model using the mercury injection capillary pressure data, deriving an initial volume-based pore size distribution for the initial pore type using the volume forward model, creating a frequency forward model using the mercury injection capillary pressure data, deriving an initial frequency-based pore size distribution for the initial pore type using the frequency forward model, selecting either the initial volume-based pore size distribution or the initial frequency-based pore size distribution based on the volume forward model and the frequency forward model to provide a selected distribution, and optimizing the selected distribution using an inversion of the mercury injection capillary pressure data with combinations of two or more pore type distributions to create an optimized distribution.

### BRIEF DESCRIPTION OF THE DRAWINGS

So that the manner in which the above recited features of the present invention can be understood in detail, a more particular description of the invention, briefly summarized above, may be had by reference to embodiments, some of which can be illustrated in the appended drawings. It can be noted, however, that the appended drawings illustrate only typical embodiments of this invention and are, therefore, not to be considered limiting of its scope, for the invention may admit to other equally effective embodiments. It can be emphasized that the figures can be not necessarily to scale and certain features and certain views of the figures can be shown exaggerated in scale or in schematic for clarity and/or conciseness.

FIG. 1 depicts a graphical and mathematical representation of a relationship between P_{c}, a, and α for an elliptical tube based on balancing forces, according to one or more embodiments described.

FIG. 2 depicts a graphical and mathematical representation of a relationship between P_{c}, a and α for an elliptical tube based on Young-Laplace equations, according to one or more embodiments described.

FIG. 3 depicts a graphical representation of a forward model example from volume-based pore size distribution to synthetic MICP curve, according to one or more embodiments described.

FIG. 4 depicts a graphical representation of an inversion of two pore types of frequency-based pore size distribution, according to one or more embodiments described.

FIG. 5 depicts an illustrative workflow for deriving individual pore size distributions for multiple pore types with different aspect ratios from MICP data, according to one or more embodiments described.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure can repeat reference numerals and/or letters in the various embodiments and across the figures provided herein. This repetition is for the purpose of simplicity and clarity and does not in itself dictate a relationship between the various embodiments and/or configurations. Moreover, the exemplary embodiments presented below can be combined in any combination of ways, i.e., any element from one exemplary embodiment can be used in any other exemplary embodiment, without departing from the scope of the disclosure.

Additionally, certain terms are used throughout the following description and claims to refer to particular components. As one skilled in the art will appreciate, various entities can refer to the same component by different names, and as such, the naming convention for the elements described herein is not intended to limit the scope of the invention, unless otherwise specifically defined herein. Further, the naming convention used herein is not intended to distinguish between components that differ in name but not function.

Furthermore, in the following discussion and in the claims, the terms “including” and “comprising” are used in an open-ended fashion, and thus should be interpreted to mean “including, but not limited to.”

The term “or” can be intended to encompass both exclusive and inclusive cases, i.e., “A or B” can be intended to be synonymous with “at least one of A and B,” unless otherwise expressly specified herein.

The indefinite articles “a” and “an” refer to both singular forms (i.e., “one”) and plural referents (i.e., one or more) unless the context clearly dictates otherwise. For example, embodiments using “a pore” include embodiments where one, two, or more pores can be present at a given sample location, unless specified to the contrary or the context clearly indicates that only one pore is present.

Unless otherwise indicated herein, all numerical values can be “about” or “approximately” the indicated value, meaning the values take into account experimental error, machine tolerances and other variations that would be expected by a person having ordinary skill in the art. It should also be understood that the precise numerical values used in the specification and claims constitute specific embodiments. Efforts have been made to ensure the accuracy of the data in the examples. However, it should be understood that any measured data inherently contains a certain level of error due to the limitation of the technique and/or equipment used for making the measurement.

Each of the appended claims defines a separate invention, which for infringement purposes can be recognized as including equivalents to the various elements or limitations specified in the claims. Depending on the context, all references to the “invention” may in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions, and examples, but the inventions are not limited to these embodiments, versions, or examples, which are included to enable a person having ordinary skill in the art to make and use the inventions when the information in this disclosure is combined with publicly available information and technology.

The terms “mercury injection capillary pressure data” and “MICP data” are used interchangeably and include a measurement of a volume of mercury that can invade pore volume of the rock and/or rock sample as a function of mercury pressure. The mercury pressure can be used as capillary pressure because mercury does not wet rock and/or rock sample surfaces.

The variable “P_{c}” represents a capillary pressure for an elliptical tube.

The variable “a_{c}” represents a critical entry size for an elliptical tube.

The variable “ƒ(a)” represents a probability density function of volume-based pore size distributions.

The variable “a” represents a semi-long axis for an elliptical tube.

The variable “b” represents a semi-short axis for an elliptical tube.

The variable “α” represents an aspect ratio, i.e., the ratio of the short axis diameter (b) over the long axis diameter (a) of a pore, for an elliptical tube.

The variable “σ” represents a surface tension of a fluid within an elliptical tube.

The variable “θ” represents a contact angle of a fluid within an elliptical tube.

The variable “E” represents an elliptical integral function of the second kind.

The variable “D_{λ}” represents fractal dimension tortuosity of an elliptical tube.

In some embodiments, the process for determining rock permeability can include acquiring one or more rock samples from a subterranean formation. The rock sample(s) can be obtained via conventional coring, sidewall coring, or any suitable method for acquiring the rock sample(s), and/or any combination thereof. The rock sample(s) can include any subterranean rock suitable for MICP testing, digital imaging, sonic measurements, and the like, and/or any combination thereof. The rock sample(s) can include any subterranean rock that is representative of the subterranean formation. In some embodiments, sonic measurements for a subterranean rock can be obtained in situ, i.e., downhole.

In some embodiments, a volume-based aspect ratio distribution of pores in the rock sample can be determined from a digital image of the rock sample. In some embodiments, the digital image can be a scanning electron microscope image. In other embodiments, pore types of a rock, e.g., the rock sample or a rock located downhole, having different average ratios of a short axis diameter over a long axis diameter (α) can be determined from sonic measurements to provide a volume-based aspect ratio distribution. The pore types can be modeled using an elliptical tube based on balancing forces, the Young-Laplace equation, or any suitable method of modeling subterranean rock pore types.

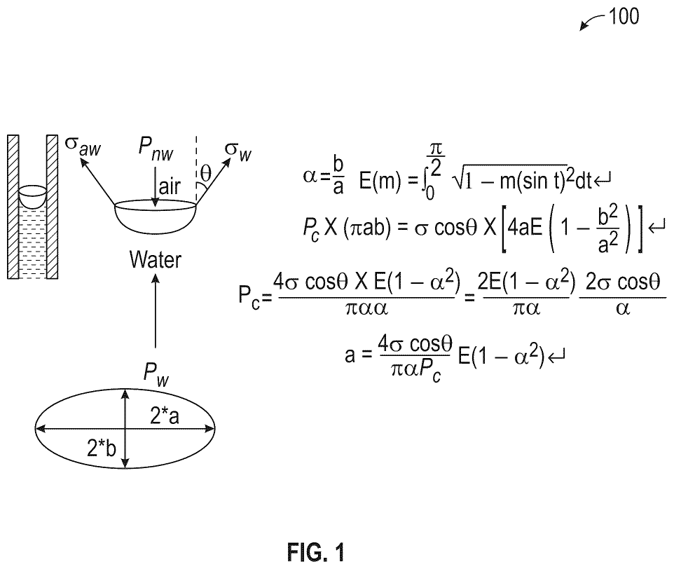

FIG. 1 depicts a graphical and mathematical representation of a relationship between P_{c}, a and α for an elliptical tube based on balancing forces 100, according to one or more embodiments. The elliptical tube can include a force pore model that provides a framework for calculating, recording, determining, or the like, and/or any combination thereof, values associated with pore types in a rock sample and/or a wellbore formation. The force pore model can be derived from the aspect ratio (α) and the elliptical integral function. The equation for a can be given as:

$$\text{?} = \frac{b}{a} .$$

$$\text{?} \text{indicates text missing or illegible when filed}$$

The force pore model can include the elliptical integral function E, where m is mass of the fluid and t is time, given as:

$$E ( m ) = \text{?} \sqrt{1 - {m ( sin t )}^{2}} dt .$$

$$\text{?} \text{indicates text missing or illegible when filed}$$

The relationship between P_{c}, a, and α for the force pore model to create a volume-based aspect ratio distribution can be derived by:

$$\text{?} \times ( π ab ) = \text{?} cos θ \times [ 4 \text{?} E ( 1 - \frac{{b}^{2}}{\text{?}} ) ] ,$$

$$\text{?} \text{indicates text missing or illegible when filed}$$

$$\text{?} = \frac{4 σ cos θ \times E ( 1 - \text{?} )}{π \text{?}} = \frac{2 E ( 1 - \text{?} )}{π \text{?}} \frac{2 \text{?} cos θ}{\text{?}} ,$$

$$and$$

$$\text{?} = \frac{4 σ cos θ}{π \text{?}} E ( 1 - \text{?} ) .$$

$$\text{?} \text{indicates text missing or illegible when filed}$$

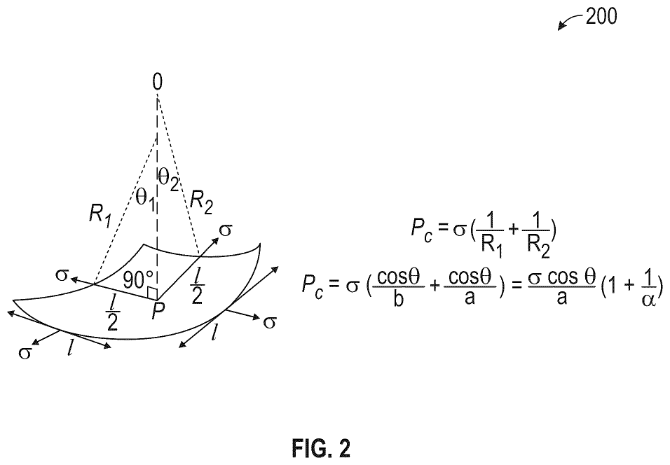

FIG. 2 depicts a graphical and mathematical representation of the relationship between P_{c}, a and α for an elliptical tube based the Young-Laplace equation 200, according to one or more embodiments. The elliptical tube can include a Young-Laplace pore model that provides a framework for calculating, recording, determining, or the like, and/or any combination thereof, values associated with pores in a rock sample and/or a wellbore formation. The Young-Laplace pore model can be derived from the aspect ratio and the Young-Laplace equation. The relationship between P_{c}, a, and α for the Young-Laplace pore model to create a volume-based aspect ratio distribution can be derived by:

$${P}_{c} = σ ( \frac{1}{{R}_{1}} + \frac{1}{{R}_{2}} ) ,$$

$$and$$

$${P}_{c} ] = σ ( \frac{cos θ}{b} + \frac{cos θ}{\text{?}} ) = \frac{σ cos θ}{\text{?}} ( 1 + \frac{1}{\text{?}} ) .$$

$$\text{?} \text{indicates text missing or illegible when filed}$$

The volume-based aspect ratio distribution can be grouped into two or more pore types. The pore types can be differentiated, identified, grouped, and the like, and/or any combination thereof, based on different values of α. The pore types can include stiff pores, reference pores, crack pores, and the like, and/or any combination thereof. The pore types can be categorized by ranges of values of α, as determined by the user, operation testing, experimental testing, reference data, and the like, and/or any combination thereof. In one or more embodiments, the pore types can be categorized automatically by a computer. In one or more embodiments, the categorized pore types can include two or more pore types from which a user can select an initial pore type for further testing and/or modeling. The selected pore type can include an initial pore type to be used as a starting point to build and/or create one or more distribution models. The initial pore type can be any pore type determined by ranges of values of a suitable for building and/or creating one or more distribution models.

Mercury injection capillary pressure data can be obtained from the rock sample(s) using MICP testing. MICP testing can include injecting a volume of mercury that can invade a pore volume of the rock sample(s). The mercury injection capillary pressure data can include the relationship between mercury pressure and mercury volume to derive a mercury capillary pressure. The mercury capillary pressure can be used with the force pore model and/or Young-Laplace pore model and the initial pore type to create forward models. The forward models can include a volume forward model and a frequency forward model. The volume forward model can be derived from the equation for a, when a is equal to a_{c}, given as:

$$\text{?} = \frac{4 σ cos θ}{π \text{?}} E ( 1 - \text{?} ) .$$

$$\text{?} \text{indicates text missing or illegible when filed}$$

The equation for a_{c} can be used to construct a volume forward model, given as:

$$\text{?} = \frac{\text{?} f ( \text{?} ) d \text{?}}{\text{?} f ( \text{?} ) d \text{?}} .$$

$$\text{?} \text{indicates text missing or illegible when filed}$$

The frequency forward model can be derived by measuring incremental elliptical tube volumes and dividing the incremental elliptical tube volumes by a single elliptical tube volume to acquire the number of elliptical tubes with a certain tube length. The tube length “L” can be expressed in terms of D_{λ}, given as:

$${L}_{i} = {L}_{d} {( \frac{{a}_{i}}{{a}_{d}} )}^{1 - {D}_{λ}} ,$$

where L_{d} is the shortest flow path associated with the biggest tube of semi-long axis a_{d}. The frequency forward model can include the equation for a, when a is equal to a_{c}, given as:

$$\text{?} = \frac{4 σ cos θ}{π \text{?}} E ( 1 - \text{?} ) .$$

$$\text{?} \text{indicates text missing or illegible when filed}$$

The equations for a_{c} and L can be used to construct a frequency forward model, given as:

$${S}_{nwt} = \frac{\text{?} f ( a ) da}{\text{?} f ( a ) da} .$$

$$\text{?} \text{indicates text missing or illegible when filed}$$

Initial pore size distributions can include an initial volume-based pore size distribution and an initial frequency-based pore size distribution. The initial volume-based pore size distribution can be derived from MICP curve directly, given as:

$${PVD}_{i} = \frac{{dS}_{nwti}}{{da}_{i}} .$$

The initial frequency-based pore size distribution can be derived from MICP curve together with single tube volume, given as:

$${PFD}_{i} = \frac{{a}_{i}^{\frac{{dS}_{nwti}}{{3 - {D}_{λ}}^{}}}}{\sum {a}_{i}^{\frac{{dS}_{nwti}}{{3 - {D}_{λ}}^{}}}} \frac{1}{{da}_{i}} .$$

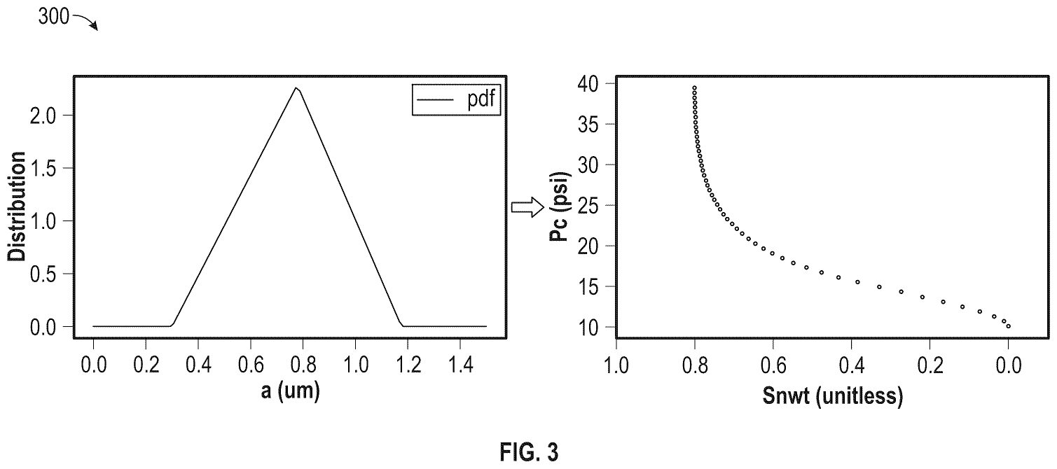

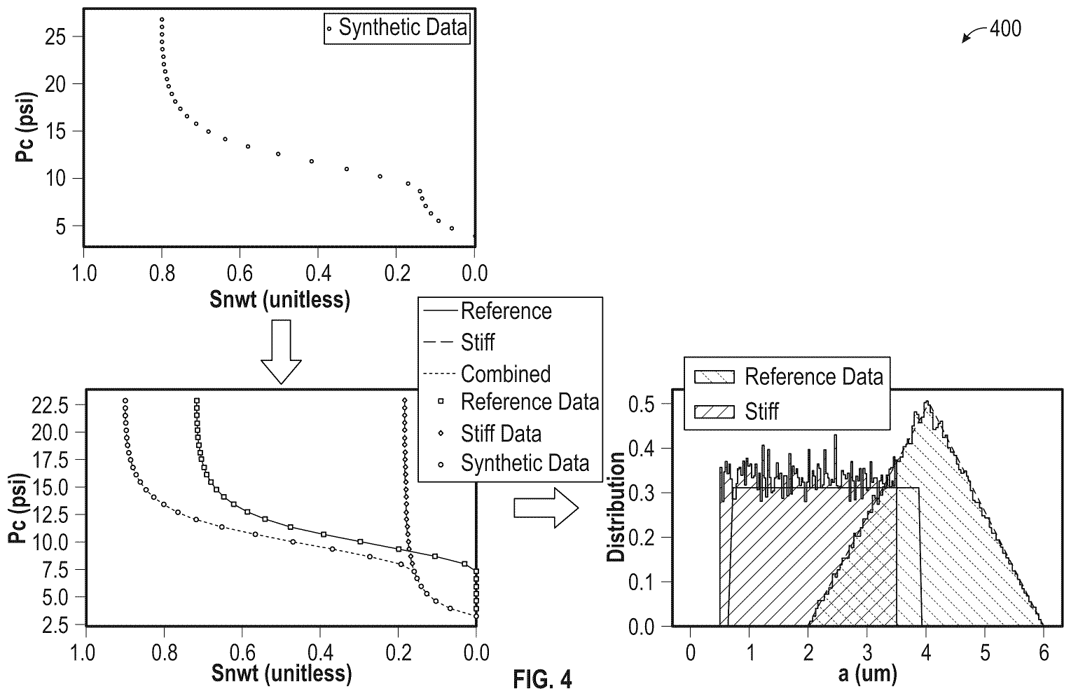

FIG. 3 depicts a graphical representation of a forward model example from volume-based pore size distribution to synthetic MICP curve 300, according to one or more embodiments. The synthetic MICP curve, as depicted in FIG. 3, can include a comparison between the capillary pressure and the volume forward model. The synthetic MICP curve can be compared to MICP testing data and/or other experimental data. FIG. 4 depicts a graphical representation of an inversion of two pore types of frequency-based pore size distribution 400, according to one or more embodiments.

A distribution from either the initial volume-based pore size distribution or the initial frequency-based pore size distribution can be selected based on the volume forward model (PVDᵢ) and the frequency forward model (PFDᵢ) to provide a selected distribution. In some embodiments, a user can select the distribution from among PVDᵢ and PFDᵢ based upon preference, ease of modeling, best fit, or the like, and/or any combination thereof. In other embodiments, a distribution from among PVDᵢ and PFDᵢ can be selected based upon ease of modeling, best fit, or the like, and/or any combination thereof via a computer.

An optimization method can be applied to the MICP data with a plurality of combinations of the selected distribution for two or more pore types. The optimization method can include an inversion using a least-square optimization method, or any suitable method for fitting a plurality of selected distribution for two or more pore types to the MICP data. The optimization method can include an inversion using a Latin hypercube sampling, or any suitable method to prevent convergence on local minima. In one or more embodiments, the volume-based pore size distribution can be simulated to further assist the optimization method. The volume-based pore size distribution can be simulated by one or more probability density distribution types selected from gaussian, triangular, uniform, beta, and the like, and/or combinations thereof.

In one or more embodiments, one or more drilling operations can be modified based at least in part on the optimized distribution. The drilling operation can include any downhole drilling process and/or operation, evaluation of the surrounding formation, or similar operation that can use information relating to and/or about pore size distribution, porosity, and the like, of a formation. In some embodiments, the modifications can include updating a reservoir matrix with the optimized distribution, updating a reservoir model to improve reservoir history matching and/or production planning, or a combination thereof. In some embodiments, the optimized distribution can be used in designing a wellbore operation. In some embodiments, the optimized distribution can be used in the design and execution of wellbore operations such as well placement, drilling, and production operations.

In some embodiments, the drilling operation can include geosteering. Geosteering can include directing, controlling, and/or manipulating the path of a drilling operation to follow a desired path. The desired path can include drilling and remaining within a desired geological layer of the formation, e.g., a topmost geological layer of the formation. The desired geological layer can include greater hydrocarbon availability as compared to surrounding geological layers. The desired geological layer can also include a region of the formation that avoids other regions of the formation that include drilling hazards, such as water columns, salt domes, and the like. In order to increase hydrocarbon production, boreholes can be drilled horizontally in the formation to remain within the desired geological layer. In one or more embodiments, the drilling operation can include already drilled boreholes, boreholes in the process of being drilled, boreholes that have yet to be drilled, and the like, or any combination thereof.

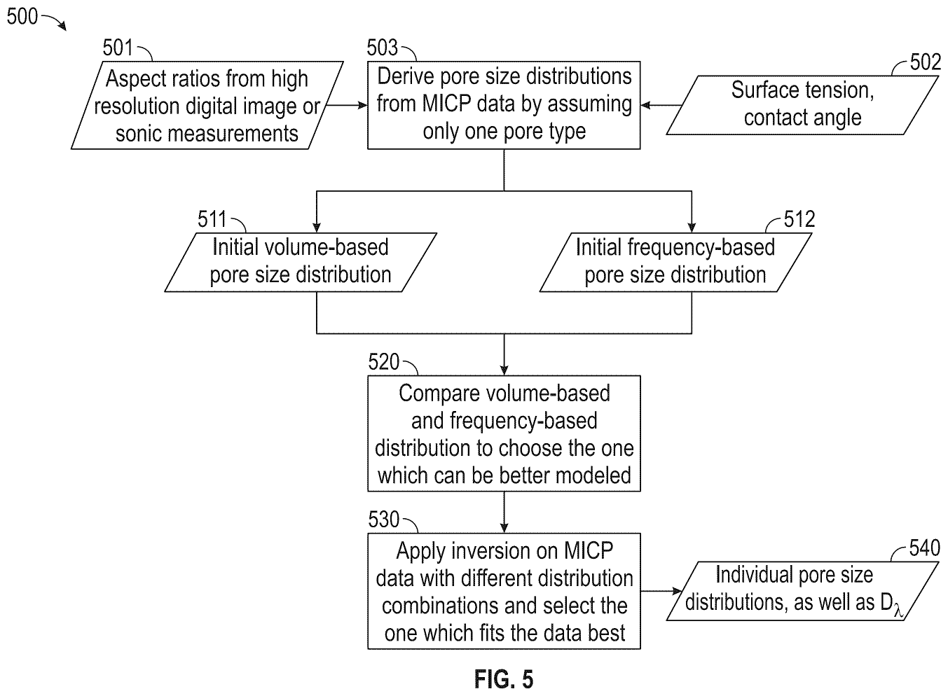

FIG. 5 depicts an illustrative workflow for deriving individual pore size distributions for multiple pore types with different aspect ratios from MICP data 500, according to one or more embodiments. The illustrative workflow 500 can include acquiring sensor data 501, acquiring fluid data 502, deriving pore size distributions 503, creating the initial volume-based pore size distribution 511, creating the initial frequency-based pore size distribution 512, comparing the initial distributions 520, optimizing the models 530, and acquiring data 540. Acquiring sensor data 501 can include acquiring data from the rock sample(s) using the digital image and/or sonic measurements. Acquiring fluid data 502 can include acquiring fluid data from MICP data. Deriving pore size distributions 503 can include combining the sensor data 501 and fluid data 502 to derive pore size distributions assuming only one pore type. Creating the initial volume-based pore size distribution 511 can include creating the volume forward model and deriving the initial volume-based pore size distribution. Creating the initial frequency-based pore size distribution 512 can include creating the frequency forward model and deriving the initial frequency-based pore size distribution. Comparing the initial distributions 520 can include selecting a preferred initial pore size distribution. Optimizing the models 530 can include using inversion and optimization methods to best fit pore size distributions to the data associated with the rock sample(s). Acquiring data 540 can include using the optimized model 530 to determine information about the pores in the rock sample(s) to modify drilling operations.

All patents and patent applications, test procedures (such as ASTM methods, UL methods, and the like), and other documents cited herein are fully incorporated by reference to the extent such disclosure can be not inconsistent with this disclosure and for all jurisdictions in which such incorporation can be permitted.

Certain embodiments and features are described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below.

The foregoing has also outlined features of several embodiments so that those skilled in the art can better understand the present disclosure. Those skilled in the art should appreciate that the present disclosure can readily be used as a basis for designing or modifying other methods or devices for carrying out the same purposes and/or achieving the same advantages of the embodiments disclosed herein. Those skilled in the art should also realize that such equivalent constructions do not depart from the spirit and scope of the present disclosure, and that various changes, substitutions, and alterations can be made without departing from the spirit and scope of the present disclosure, and the scope thereof can be determined by the claims that follow.

We claim:

1. A process for determining rock permeability, comprising:
acquiring a rock sample from a subterranean formation;
determining a volume-based aspect ratio distribution of pores in the rock sample from a digital image of the rock sample;
grouping the volume-based aspect ratio distribution into two or more pore types;
selecting an initial pore type from the two or more pore types;
obtaining mercury injection capillary pressure data of the rock sample;
creating a volume forward model using the mercury injection capillary pressure data;
deriving an initial volume-based pore size distribution for the initial pore type using the volume forward model;
creating a frequency forward model using the mercury injection capillary pressure data;
deriving an initial frequency-based pore size distribution for the initial pore type using the frequency forward model;
selecting either the initial volume-based pore size distribution or the initial frequency-based pore size distribution based on the volume forward model and the frequency forward model to provide a selected distribution; and
optimizing the selected distribution using an inversion of the mercury injection capillary pressure data with combinations of two or more pore type distributions to create an optimized distribution.

2. The process of claim 1, wherein the digital image of the rock sample is a scanning electron microscope image.

3. The process of claim 1, wherein the mercury injection capillary pressure data comprises a surface tension and a contact angle.

4. The process of any one of claim 1, wherein grouping the volume-based aspect ratio distribution into two or more pore types is based on calculating an average ratio of a short axis diameter over a long axis diameter (α) for each pore type.

5. The process of any one of claim 1, wherein deriving the initial volume-based pore size distribution for the initial pore type and deriving the initial frequency-based pore size distribution for the initial pore type uses a relationship between a capillary pressure, a long axis diameter, and the aspect ratio according to the following equation:
$$\text{?} = \frac{4 \text{?} cos θ \times E ( 1 - \text{?} )}{π aa} .$$
$$\text{?} \text{indicates text missing or illegible when filed}$$

6. The process of any one of claim 1, wherein deriving the initial volume-based pore size distribution for the initial pore type and deriving the initial frequency-based pore size distribution for the initial pore type uses a relationship between capillary pressure, long axis diameter, and the aspect ratio according to the Young-Laplace equation:
$$\text{?} = σ ( \frac{cos θ}{b} + \frac{cos θ}{a} ) = \frac{σ cos θ}{a} ( 1 + \frac{1}{a} ) .$$
$$\text{?} \text{indicates text missing or illegible when filed}$$

7. The process of any one of claim 1, wherein the initial volume-based pore size distribution for the initial pore type utilizes the following equation:
$${PVD}_{i} = \frac{{dS}_{nwti}}{{da}_{i}} .$$

8. The process of any one of claim 1, wherein the volume forward model utilizes the following equation:
$${S}_{nwt} = \frac{\text{?} f ( a ) da}{\text{?} f ( a ) da} .$$
$$\text{?} \text{indicates text missing or illegible when filed}$$

9. The process of any one of claim 1, wherein the initial frequency-based pore size distribution for the initial pore type utilizes the following equation:
$${PFD}_{i} = \frac{{a}_{i}^{\frac{{dS}_{nwti}}{{3 - {D}_{λ}}^{}}}}{\sum {a}_{i}^{\frac{{dS}_{nwti}}{{3 - {D}_{λ}}^{}}}} \frac{1}{{da}_{i}} .$$

10. The process of any one of claim 1, wherein the frequency forward model utilizes the following equation:
$${S}_{nwt} = \frac{\text{?} f ( a ) da}{\text{?} f ( a ) da}$$
$$\text{?} \text{indicates text missing or illegible when filed}$$

11. The process of any one of claim 1, wherein optimizing the selected distribution using the inversion of the mercury injection capillary pressure data includes a least-square optimization method.

12. The process of any one of claim 1, wherein optimizing the selected distribution using the inversion of the mercury injection capillary pressure data includes Latin hypercube sampling to prevent convergence on local minima.

13. The process of any one of claim 1, wherein the volume-based pore size distribution is simulated by one or more probability density distribution types selected from gaussian, triangular, uniform, and beta.

14. The process of any one of claim 1, further comprising modifying one or more drilling operations based at least in part on the optimized distribution, updating a reservoir matrix with the optimized distribution, updating a reservoir model to improve reservoir history matching and/or production planning, or a combination thereof.

15. A process for determining rock permeability, comprising:
determining pore types of a rock having different average ratios of a short axis diameter over a long axis diameter (α) from sonic measurements to provide a volume-based aspect ratio distribution;
grouping the volume-based aspect ratio distribution into two or more pore types;
selecting an initial pore type from the two or more pore types;
obtaining mercury injection capillary pressure data of the rock sample;
creating a volume forward model using the mercury injection capillary pressure data;
deriving an initial volume-based pore size distribution for the initial pore type using the volume forward model;
creating a frequency forward model using the mercury injection capillary pressure data;
deriving an initial frequency-based pore size distribution for the initial pore type using the frequency forward model;
selecting either the initial volume-based pore size distribution or the initial frequency-based pore size distribution based on the volume forward model and the frequency forward model to provide a selected distribution; and
optimizing the selected distribution using an inversion of the mercury injection capillary pressure data with combinations of two or more pore type distributions to create an optimized distribution.

16. The process of claim 15, wherein the mercury injection capillary pressure data includes surface tension and contact angle.

17. The process of claim 15, wherein grouping the volume-based aspect ratio distribution into two or more pore types includes grouping based on calculating an average ratio of a short axis diameter over a long axis diameter (α) for each pore type.

18. The process of any one of claim 15, wherein deriving an initial volume-based pore size distribution for the initial pore type and deriving an initial frequency-based pore size distribution for the initial pore type uses a relationship between capillary pressure, long axis diameter, and the aspect ratio, comprising:
$$\text{?} = \frac{4 \text{?} cos θ \times E ( 1 - {a}^{2} )}{π \text{?} a} .$$
$$\text{?} \text{indicates text missing or illegible when filed}$$

19. The process of any one of claim 15, wherein deriving the initial volume-based pore size distribution for the initial pore type and deriving the initial frequency-based pore size distribution for the initial pore type uses a relationship between capillary pressure, long axis diameter, and the aspect ratio according to the Young-Laplace equation:
$$\text{?} = σ ( \frac{cos θ}{b} + \frac{cos θ}{a} ) = \frac{σ cos θ}{a} ( 1 + \frac{1}{a} ) .$$
$$\text{?} \text{indicates text missing or illegible when filed}$$

20. The process of any one of claim 15, wherein the initial volume-based pore size distribution for the initial pore type utilizes the following equation:
$${PVD}_{i} = \frac{{dS}_{nwti}}{{da}_{i}} .$$

21. The process of any one of claim 15, wherein the volume forward model utilizes the following equation:
$${S}_{nwt} = \frac{\text{?} f ( a ) da}{\text{?} f ( a ) da} .$$
$$\text{?} \text{indicates text missing or illegible when filed}$$

22. The process of any one of claim 15, wherein the initial frequency-based pore size distribution for the initial pore type utilizes the following equation:
$${PFD}_{i} = \frac{{a}_{i}^{\frac{{dS}_{nwti}}{{3 - {D}_{λ}}^{}}}}{\sum {a}_{i}^{\frac{{dS}_{nwti}}{{3 - {D}_{λ}}^{}}}} \frac{1}{{da}_{i}} .$$

23. The process of any one of claim 15, wherein the frequency forward model utilizes the following equation:
$${S}_{nwt} = \frac{\text{?} f ( a ) da}{\text{?} f ( a ) da}$$
$$\text{?} \text{indicates text missing or illegible when filed}$$

24. The process of any one of claim 15, wherein optimizing the selected distribution using the inversion of the mercury injection capillary pressure data includes a least-square optimization method.

25. The process of any one of claim 15, wherein optimizing the selected distribution using the inversion of the mercury injection capillary pressure data includes Latin hypercube sampling to prevent convergence on local minima.

26. The process of any one of claim 15, wherein the volume-based pore size distribution is simulated by one or more probability density distribution types selected from gaussian, triangular, uniform, and beta.

27. The process of any one of claim 15, further comprising modifying one or more drilling operations based at least in part on the optimized distribution, updating a reservoir matrix with the optimized distribution, updating a reservoir model to improve reservoir history matching and/or production planning, or a combination thereof.
